(19) United States
(12) Patent Application Publication
(10) Pub. No.: US 2004/0121119 A1
(43) Pub. Date: Jun. 24, 2004

(54) Fabric holding assembly and manufacturing process

(76) Inventors: Kenneth R. Levey, West Chicago, IL (US); Kenneth A. Longstreet, Grant, MI (US); Randy J. Sayers, Belding, MI (US); Pierre Tremblay, Clarksville, MI (US)

Correspondence Address: PAUL F. DONOVAN, ILLINOIS TOOL WORKS INC., 3600 WEST LAKE AVENUE, GLENVEIW, IL, 60025, US

(21) Appl. No.: 10/657,518

(22) Filed: Sep. 8, 2003

Related U.S. Application Data
(60) Provisional application No. 60/428,599, filed on Nov. 22, 2002.

(51) Int. Cl. B32B 3/04

(52) U.S. Cl. 428/122

(57) ABSTRACT

A fabric having a plastic member integrally connected thereto. A frame member component of plastic is provided with a metal wire extending therethrough. The frame member component is placed in contact with the web, and the wire is heated to soften the plastic of the frame member component, bonding it to the web.

### CROSS-REFERENCE TO RELATED APPLICATIONS

The present application claims the benefits of United States Provisional Application Serial No. 60/428,599 filed Nov. 22, 2002.

### FIELD OF THE INVENTION

The present invention relates to articles of manufacture having a suspended or stretched fabric component, such as lawn chairs and other furniture; and more particularly, the present invention relates to an assembly for holding a piece of material, such as fabric, between two members.

### BACKGROUND OF THE INVENTION

Many articles of manufacture include stretched fabric components. For example, it is known to provide stretched fabric or stretched woven webs on furniture such as lawn furniture, home furniture, office seating, automotive seating, airline seating and the like. In a known process for manufacturing such articles, a ridged frame is provided with a channel therein. The fabric is attached to a sub-frame component, such as a metal or plastic extrusion, and the sub-frame member is inserted in the channel of the ridged frame.

The known procedures and structures that have been used for attaching the fabric to the sub-frame member have created difficulties and disadvantages. It is known to wrap a margin portion of the fabric at least partly around the sub-frame component, and to fasten the fabric to the sub-frame by means of rivets, screws or other fasteners. A disadvantage of this construction is that it can be time consuming and expensive to complete. Further, the strains and forces exerted on the fabric are localized at the discrete points of attachment between the fabric and sub-frame, thereby requiring reinforcement of the fabric such as with grommets, or the use of stronger fabrics.

It is also known to wrap the fabric around the sub-frame member completely, thereby encircle the sub-frame member, and to stitch the wrapped fabric to itself, thereby forming a sleeve in which the sub-frame member is received. This construction also presents disadvantages, including the time required for stitching the fabric and the need to use additional fabric material sufficient to wrap the sub-frame member and complete the stitched scam. The additional time required in manufacture, and the need for additional fabric to form the sleeve add significant cost and expense to the completed article. When the material is stitched, needles can cause damage to fibers, weakening the fabric. Further, the frame member is loosely received in the sleeve, allowing some relative relocation of the frame member and fabric. The sliding friction created can cause premature wear of the material forming the sleeve, leading to premature failure of the article. During assembly, the sub-frame member can slide completely out of the sleeve.

It also is known to attached fabrics to frames using adhesives and with heat fusible resins. However, the materials required and processes of manufacture are expensive and require expensive and complicated equipment. Some are limited in the frame geometry for which the process can be used. Some are no less wasteful of fabric than are various sewing techniques.

What is needed in the art is a procedure and construction by which fabric can be joined directly to a frame member using a minimal amount of fabric, decreasing production time and distributing forces more evenly along the length of the frame member.

### SUMMARY OF THE INVENTION

The present invention provides a process by which a frame component is bonded directly on to a fabric web using induction heating of a target component embedded in the frame component to heat and melt the frame material.

In one form thereof, the present invention provides a fabric assembly for suspension in a frame. A fabric web has an edge and a margin portion adjacent the edge. A frame member is bonded to the margin portion. A heat-localizing member is provided within the frame member and is conductive for receiving and localizing heat to facilitate bonding of the frame member and the web by transfer of heat from the heat localizing member to the frame member.

In another form thereof, the present invention provides a method for making a suspendable web with steps of providing a fabric web; forming a frame member having a heat conductor embedded therein; placing the frame member on the web; and heating the heat conductor to transfer heat to the frame member and thereby softening the frame member to bond the frame member and web together

In still another form thereof, the present invention provides a method for attaching a plastic member to a fabric web with steps of: forming the plastic member in complementary male and female components; embedding a heat conducting element in at least one of the components; positioning the components on opposite sides of the web; heating the heat conducting element sufficiently to soften plastic from at least one of the components; and hardening the softened plastic to bond the member to the web.

An advantage of the present invention is providing a process by which a frame member can be attached directly to a fabric web, thereby integrally bonding the frame member and fabric together.

Another advantage of the present invention is providing an integral frame and fabric assembly that distributes forces along the length of the frame, eliminating localization of the forces at connecting points between the fabric and frame.

Still another advantage of the present invention is providing a frame and fabric construction reducing the amount of fabric material required for the assembly.

A further advantage is providing a process by which an extruded frame member can be attached to a fabric web with reduced manufacturing time and expense.

A still further advantage of the present invention is providing a frame and fabric construction that seals the fabric edge, minimizing the potential for fraying.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a fabric and frame member assembly in accordance with the present invention;

FIG. 2 is an enlarged, fragmentary perspective view of a portion of the assembly shown in FIG. 1;

FIG. 3 is a perspective view of another form of an assembly in accordance with the present invention;

FIG. 4 is a cross-sectional view of the assembly shown in FIG. 3, the cross section having been taken along line 4-4 of FIG. 3;

FIG. 5 is a schematic illustration of a suitable manufacturing process in accordance with the present invention for making the frame components; and

FIG. 6 is a schematic illustration of an assembly process for assembling a fabric holding assembly in accordance with the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

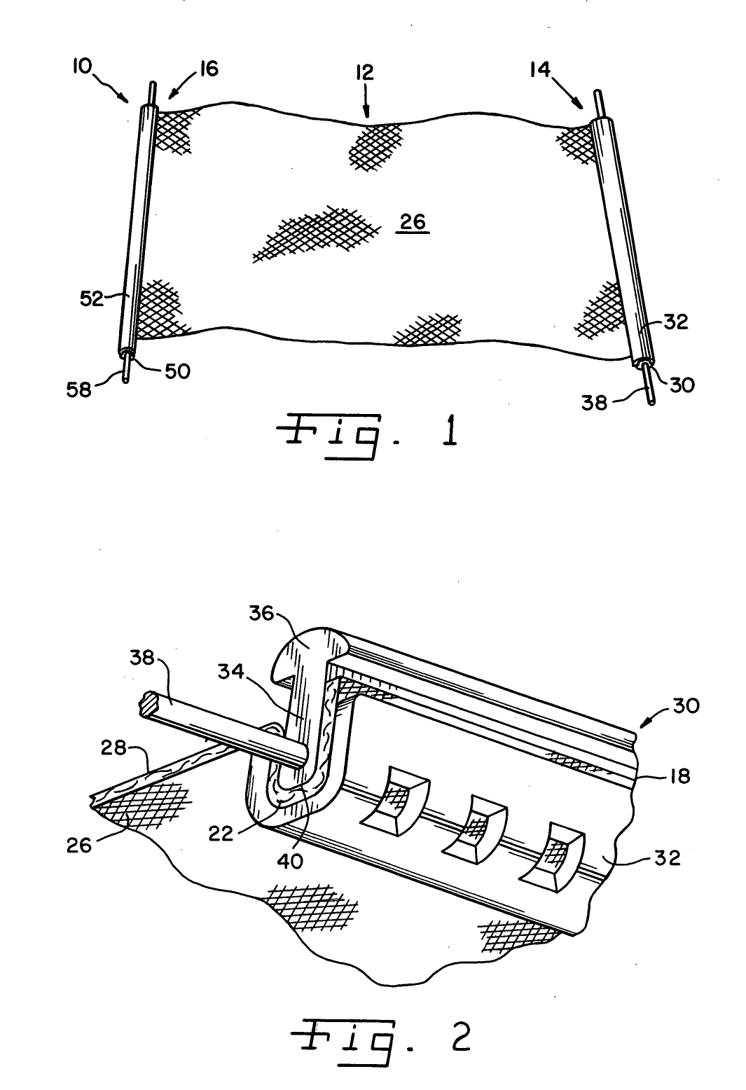

Referring now more specifically to the drawings and to FIG. 1 in particular, numeral 10 designates a suspendable fabric assembly in accordance with the present invention. Assembly 10 includes a fabric web 12 and first and second frame members 14 and 16, on opposite sides thereof. Assembly 10 is suitable for suspension in a frame, as known to those skilled in the art, and can be used for the manufacture of lawn furniture, office furniture and other structures requiring suspension of a material web between supporting members.

Web 12 can be of any material suitable for the final application and use for assembly 10. Woven cloth fabrics of both natural and man-made fibers are suitable, as are other synthetic fabrics of plastic or the like. Web 12 can be provided in different weave patterns, as desirable and advantageous for the final use and application of assembly 10.

Web 12 has first and second edges 18 and 20, respectively, and first and second margin portions 22 and 24 adjacent edges 18 and 20, respectively. First and second frame members 14 and 16 are adhered to web 12 along first and second margin portions 22 and 24 respectively. The width of web 12 is selected for the final use of suspendable web 12, and substantially the full width of web 12 is used, without the need for extra width of web 12 to wrap frame members 14 and 16. Only a small amount of web 12 is required for capture in frame members 14 and 16. Web 12 has opposed surfaces 26 and 28, and margin portions 22 and 24 extend inwardly from edges 18 and 20, respectively, on each surface 26 and 28. Thus, first margin portion 22 extends inwardly from first edge 18 on both surfaces 26 and 28, and second margin portion 24 extends inwardly from second edge 20 on both surfaces 26 and 28.

Assembly 10 is shown with two frame members 14 and 16 attached thereto on opposite edges 18 and 20. However, it should be understood that the present invention is useful for attaching more or fewer frame members to fabric web 12, for attaching frame members on adjacent edges of fabric 12, and even for attaching a plastic body at an intermediate location between edges of fabric web 12.

First and second frame members 14 and 16 are made of extrudable material, such as plastic, suitable for the final application and use of suspendable fabric assembly 10. Members 14 and 16 encapsulate edges 18 and 20, respectively, with each body 16 and 18 adhered to opposed first and second surfaces 26 and 28 of margins 22 and 24, respectively.

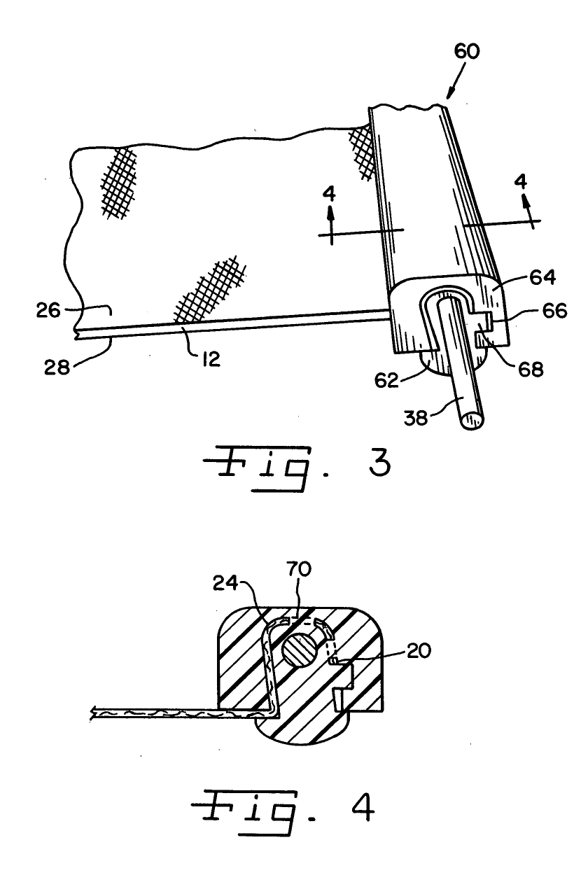

First frame member 14 includes a male component 30 and a female component 32 provided on opposite sides of fabric web 12. Male component 30 is somewhat T-shaped in cross section, having an elongated base 34 and a dome 36. Female component 32 is a U-shaped channel in which base 34 of male component 30 is loosely received. First margin portion 22 of web 12 is disposed between male component 30 and female component 32 in a clamping-like arrangement as shown in FIG. 2.

An elongated, heat-localizing, conductive member 38 is disposed within base 34 of male member 30, near a bottom edge 40 thereof. Heat localizing, conductive member 38 is a wire or rod of metal to facilitate welding or bonding of male and female components 30 and 32 to fabric web 12. Copper is a suitable material for heat localizing member 38, although other metals and non-metal materials also can be used. During manufacture of assembly 10, heat localizing conductive member 38 is heated, and transfers heat to male and female components 30 and 32, causing localized softening and melting thereof to facilitate bonding with fabric web 12.

Second frame member 18 is similar to first frame 16, having a male component 50, a female component 52 and a heat-localizing, conductive member 58. However, first and second frame members 16 and 18 need not be the same, and can be differently configured as advantageous for final use of assembly 10.

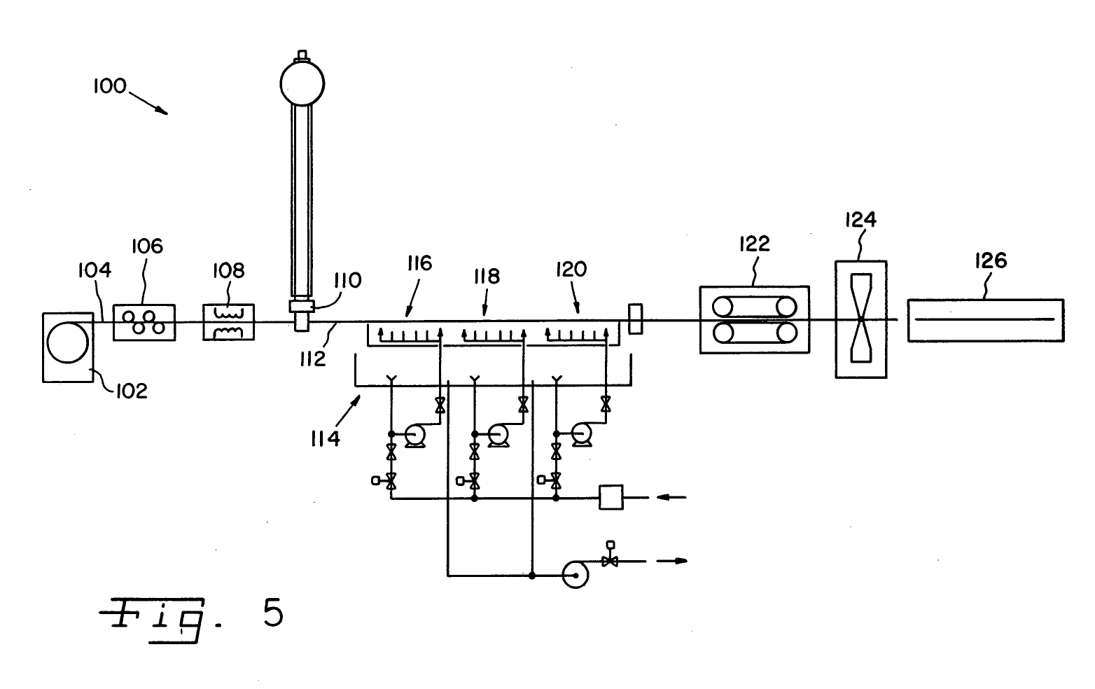

FIGS. 3 and 4 illustrate a modified frame member 60 including a modified male component 62 and a modified female component 64. A groove 66 is provided in female component 64 to receive a flange 68 from male component 62. Male and female components 62 and 64 are thereby interlocking, to facilitate assembly. Frame member 60 includes a heat-localizing, conductive member 38 as described previously. Other types of interlocking constructions also can be used, such as, for example, interference fits, snap fits, undercut fits and the like that will trap and hold the fabric to facilitate assembly.

Heat localizing, conductive members 38 and 58 can be heated by a variety of different processes. For example, the assembly of fabric web 12, male and female components 30, 50 or 62 and 32, 52 or 64 and heat localizing conductive members 38 or 58 can be passed through an induction heater. In the induction heater, sufficient heat is generated within conductive members 38, 58 to cause localized softening of the plastic material of male and female components 30, 50, 62 and 32, 52, 64, facilitating bonding thereof to each other and to fabric web 12 therebetween. The intermingling of plastic from male members 30, 50, 62 and female members 32, 52, 64 with fabric web 12 is indicated by region 70 in FIG. 4 with respect to modified frame member 60. Pressure can be applied together with heating to further facilitate bonding with fabric web 12. With sufficient heat and pressure, plastic from frame members 14, 16 and 60 can be caused to flow through web 12, between the fibers thereof, creating an interlocking bond with the fibers upon cooling.

It should be understood that the configurations of the separate parts of the frame members can vary as needed for the final use of assembly 10. The shapes of male components 30, 50, 62 and female components 32, 52, 64 shown and described herein are merely for illustration purposes in explaining the present invention, and should not be considered limiting on the present invention. Further, while heat localizing members 38 and 58 have been shown and described herein to be imbedded in male components 30, 50 and 62, heat localizing members 38, 58 instead could be provided in female components 32, 52 and 62, or in both the male and female components.

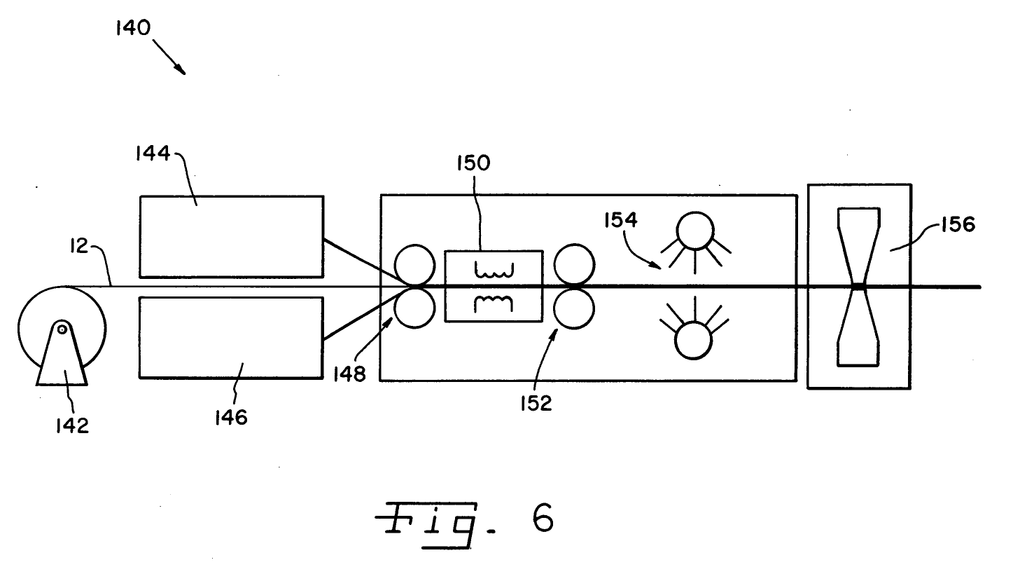

Manufacture of assembly 10 can include inline profile extrusion or injection molding with heat localizing member 38, 58 imbedded during the extrusion or injection molding process of one of the frame members, or both members. FIG. 5 illustrates one suitable forming process 100. A wire dispenser 102 dispenses a continuous strand of wire 104 to a wire straightener 106. The straightened wire is passed through a heater 108, which may be an induction heater or other conventional heating means. Wire 104 is heated to facilitate bonding with plastic to be extruded thereon. Alternative, heating wire 104 can be omitted, if sufficient bonding occurs without heating. The straightened and heated wire is moved to an extruder 110, at which the desired configuration of a frame component extrusion 112, such as for example male component 30, is formed on and around wire 104. The formed extrusion 112, with wire 104 embedded therein, is passed from extruder 110 to a cooling section 114, which may include a plurality of cooling zones 116, 118, 120 as needed. Three cooling zones 116, 118 and 120 are shown in FIG. 5; however, more or fewer zones can be used. Within cooling section 114, cooling can occur naturally by convection with ambient air, or blowers can be used to increase air movement, and active chilling circuits can be provided, as needed. Movement of extrusion 112 along process 100 is controlled with a pull control unit 122. A cutter 124 is provided for segmenting extrusion 112 into desirable lengths for accumulation in a storage cartridge 126.

A similar process, with or without embedding of wire, can be used for forming a complementary frame component, such as female component 32.

FIG. 6 illustrates a suitable assembling process 140 for assembling fabric assembly 10. A web dispenser 142 dispenses web 12, and male and female component dispensers 144 and 146 apply male component 30 and female component 32, respectively to web 12. A pinch roll couple 148 presses frame components 30 and 32 together as the assembled parts are fed to an induction heater 150. Wire 104, functioning as heat localizing member 38, is heated in induction heater 150 and transfers heat to male and female components 30 and 32. The plastic material of male and female components 30 and 32 is heated and softened, to bond with web 12. Pressure to facilitate bonding is provided by second pinch roll couple 152, which may be within or after induction heater 150, to press components 30 and 32 together during or just after heating. A cooling section 154 is provided to complete bonding of the softened frame member components to the web. A cutter 156 is provided to cut web 12 and or assembled frame members 14, 16.

Induction heater 150 is provided with appropriate geometry to provide even heating along the length of assembly 10, thereby allowing for even heating of conductive member 38. If heater 150 is encapsulated in nonconductive material it can be used also to apply pressure directly or indirectly against frame members 14 and 16. Controlling power applied and frequency at heater 150, residence time of the assembly therein and pressure applied in relationship to material characteristics such as thermal conductivity achieves the desired level of softening or melting in frame members 14, 16.

It should be understood that forming process 100 and assembling process 140 can be combined in a single process line, without the need for a storage cartridge 126 and subsequent component dispensers 144 and 146. The components can be formed and assembled on web 12 in a continuous process. As yet another alternative, components 30 and 32 can be extruded directly on web 12. Frame members also can be formed by other techniques, such as injection molding, and subsequently placed on fabric web 12. Fabric web 12 can be stretched before bonding to frame members 14 and 16, to reduce post assembly fabric distortion.

The process for forming a fabric holding assembly, and the fabric holding assembly formed thereby of the present invention provide improved suspension webs for use in furniture and other similar articles. Production steps are reduced and costs minimized, with fewer steps required. Web 12 can be less wide than with previous processes, since it is no longer necessary to use the margin of the fabric to wrap a sub-frame. Therefore, material requirements are reduced and costs are lessened. A stronger, less expensive suspendable web is provided, with frame member components thereof bonded to the web along extended lengths to distribute forces more evenly.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A fabric assembly for suspension in a frame, comprising:
a web having an edge and a margin portion adjacent said edge;
a frame member bonded to said margin portion; and
a heat localizing member is provided within said frame member, said heat localizing member being conductive for receiving and localizing heat to facilitate bonding of said frame member and said web by transfer of heat from said heat localizing member to said frame member.

2. The web assembly of claim 1, said fabric having two said edges with two said margin portions, and two said frame members.

3. The web assembly of claim 1, said frame member including components on opposite sides of said fabric web.

4. The web assembly of claim 3, said frame member components having interlocking structures.

5. The web assembly of claim 4, said frame member components being plastic.

6. The web assembly of claim 5, said heat localizing member being metal.

7. The web assembly of claim 1, said heat localizing member being metal.

8. A method for making a suspendable web, said method comprising steps of:
providing a fabric web;
forming a frame member having a heat conductor embedded therein;
placing the frame member on the web; and
heating the heat conductor to transfer heat to the frame member and thereby softening the frame member to bond the frame member and web together.

9. The method of claim 8, said step of forming a frame member including forming complementary frame member components, and said step of placing the frame member on the web including placing the complementary frame member components on opposite sides of the web.

10. The method of claim 8, said step of forming a frame member performed by extruding plastic on a wire.

11. The method of claim 8, said step of heating performed by induction heating.

12. The method of claim 11, said step of forming a frame member including forming complementary frame member components, and said step of placing the frame member on the web including placing the complementary frame member components on opposite sides of the web.

13. The method of claim 12, including pressing the complementary frame member components together at least one of during or after said heating step.

14. The method of claim 13, said step of forming a frame member performed by extruding plastic on a wire.

15. The method of claim 14, including heating the wire before extruding plastic onto the wire.

16. The method of claim 8, said step of placing the frame member on the web performed by extruding the frame member onto the web.

17. The method of claim 8, said step of forming a frame member including forming complementary frame member components having interlocking structures, and said step of placing the frame member on the web including placing the complementary components on opposite sides of the web and interlocking the interlocking structures.

18. The method of claim 17, said step of heating performed by induction heating.

19. The method of claim 8, including pressing the frame member and web together at least one of during or after said heating step.

20. A method for attaching a plastic member to a fabric web, said method comprising steps of:
forming the plastic member in complementary male and female components;
embedding a heat conducting element in at least one of the components;
positioning the components on opposite sides of the web;
heating the heat conducting element sufficiently to soften plastic from at least one of the components; and
hardening the softened plastic to bond the member to the web.

21. The method of claim 20, said heating step performed by induction heating.

22. The method of claim 20, including pressing the web and plastic component together at least one of during and after said heating step.
